(19) United States
(12) Patent Application Publication
(10) Pub. No.: US 2011/0271717 A1
(43) Pub. Date: Nov. 10, 2011

(54) SYSTEM AND METHOD FOR CONTROL OF GLASS TRANSMITTANCE

(75) Inventors: Patrick D. Watson, Portage, WI (US); Brad Hickman, Salem, WV (US); Kelly Jae Busch, Waunakee, WI (US)

(73) Assignee: CARDINAL FG COMPANY, Eden Prairie, MN (US)

(21) Appl. No.: 12/814,204

(22) Filed: Jun. 11, 2010

Related U.S. Application Data
(60) Provisional application No. 61/332,049, filed on May 6, 2010.

(51) Int. Cl. C03B 5/225; C03B 5/235

(52) U.S. Cl. 65/134.4

(57) ABSTRACT

This application relates to methods of making glass compositions, and glasses resulting from these methods. More particularly, the disclosure relates to a method of making a glass having high total solar transmittance and high light transmittance in the visible and near infrared ranges with the use of oxygen-fuel burners in a furnace. Such glass compositions are useful, for example, in glass-based solar cells.

### RELATED APPLICATIONS

This application claims the benefit of U.S. Provisional Application Ser. No. 61/332,049, titled Control of Glass Transmittance with Oxygen-Fuel Burners, filed May 6, 2010, the entire contents of which is hereby incorporated by reference.

### FIELD OF THE INVENTION

The invention provides methods of controlling the transmittance of glass substrates with the use of oxygen-fuel burners.

### BACKGROUND OF THE INVENTION

Glass-based solar cells and solar cells having a glass sheet as the top layer are increasing in popularity. Generally, glass-based solar cells include a glass substrate with a photovoltaic coating. The photovoltaic coating is generally on the side of the glass substrate that is opposite the direction of sunlight travel, such that the light must travel through the glass before it reaches the photovoltaic coating. Accordingly, it is desirable that glass used in these applications has a high solar transmittance.

Glass used in architectural applications, sometimes referred to as “clear glass,” typically has a solar transmittance of about 75-85%, depending on the composition of the glass and if the glass carries any functional coatings, such as low-emissivity coatings. It becomes increasingly hard to achieve an incremental unit of transmittance as the transmittance percentage increases, such as it is much harder to increase transmittance from 88% to 89% than to increase it from 78% to 79%. Thus, as transmittance numbers in the upper 80s or low 90s are achieved for silica based glass, even an increase in transmittance of 0.5% is considered a substantial improvement within the industry, especially if the means of improvement do not create other disadvantages.

Some glass forming ingredients, such as iron, have less color in their more oxidized state. Accordingly, in past efforts to increase transmission values, additional oxidizers, such as cerium, have been added to the glass forming ingredients to increase the oxidative state of these glass forming ingredients. However, such oxidizers themselves frequently change color when exposed to sunlight because the ferric iron will revert back to the ferrous state. This effect has been referred to as “solarizing.” Accordingly, the increased use of these materials creates glass with a transmission value that will decrease over time upon exposure to sunlight.

### SUMMARY OF THE INVENTION

The invention relates to methods of making glass compositions, and glasses resulting from these methods. More particularly, the invention relates to a method of making glass having high total solar transmittance and high light transmittance in the visible range and near infra red range through an oxidative environment provided by the use of oxygen-fuel burners. Such glass compositions are useful, for example, in glass-based solar cells.

Embodiments of the invention include a method of increasing transmittance of glass. In some embodiments, the method includes the step of introducing glass forming ingredients into a furnace having a melting zone and a fining zone downstream of the melting zone. Steps of the invention can also include melting the glass forming ingredients into molten glass in the melting zone with burners directed toward the glass forming ingredients. In some embodiments, the molten glass is fined in the fining zone with multiple oxygen-fuel burners directed toward the molten glass. Such a method increases the transmittance of the finished glass product, rendering the glass product particularly useful for glass-based solar cell applications and other clear glass product. Embodiments of the invention also include glass, and solar cells having glass, made by such a method and float-glass, rolled-glass, and patterned-glass lines having oxygen-fuel burners in a downstream burner position.

### BRIEF DESCRIPTION OF THE DRAWINGS

FIG. 1 is a schematic side view of a float-glass line in accordance with an embodiment of the invention.

FIG. 2 is a schematic side view of a float-glass line having an oxygenation zone in accordance with an embodiment of the invention.

FIG. 3 is a schematic top view of a float-glass line in accordance with an embodiment of the invention.

### DETAILED DESCRIPTION OF PREFERRED EMBODIMENTS

The following detailed description is to be read with reference to the drawings, in which like elements in different drawings have like reference numbers. The drawings, which are not necessarily to scale, depict selected embodiments and are not intended to limit the scope of the invention. Skilled artisans will recognize that the given examples have many alternatives that fall within the scope of the invention.

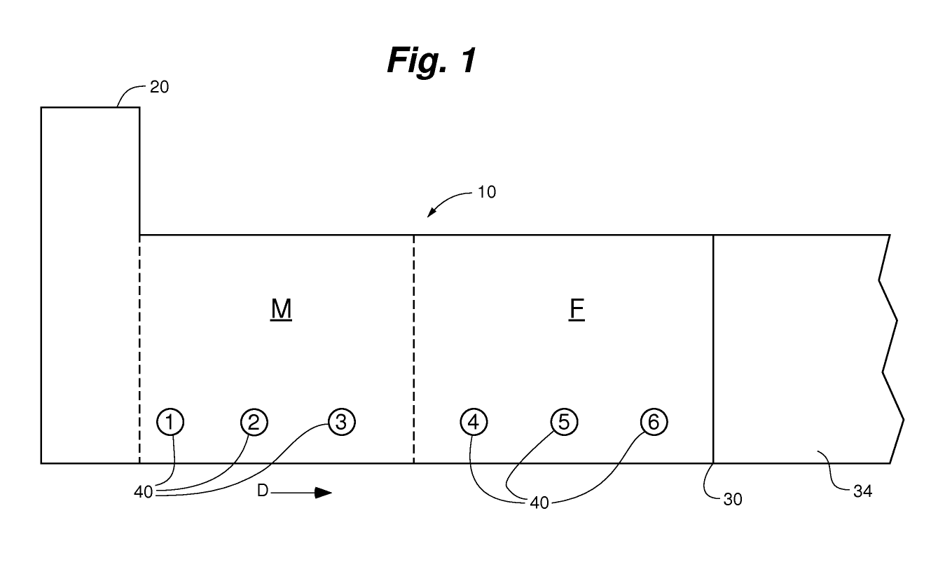

Referring to FIG. 1, a float-glass line includes a glass melting furnace 10. The furnace includes a charging end 20 where the glass-making materials (sometimes referred to herein as “batch”) are introduced to the furnace. The furnace also includes a molten glass discharge end 30 where the molten glass is expelled from the furnace. The direction of travel of the glass-making through the furnace from the charging end 20 to the discharge end 30 is shown by arrow D. The float-glass line also includes a float section 34 (e.g., a molten tin bath) downstream of the furnace. The molten glass is delivered to the float section where it floats on the molten tin bath. The thickness of the finished planar glass product is established in the float section. The glass can then conveyed away from the float bath section to an annealing lehr where desired stresses can be achieved before cutting and packing of the final glass product.

As shown in FIG. 1, the furnace has a melting zone M for melting the batch proximate the charging end 20 and a fining zone F for fining the molten glass after the batch has been melted in the melting zone. The glass making ingredients are introduced in the melting zone of the furnace, and the vast majority of the glass making ingredients are melted in the melting zone. For the purposes of this disclosure, the section of the furnace containing significant unmelted batch solids floating on the surface of a molten glass bath is defined as the melting zone.

The fining zone is located downstream of the melting zone in the direction of travel of the glass making material as it moves through the furnace in a float-glass line. For the purpose of this disclosure, the fining zone is defined as that section of the furnace not containing significant un-melted batch solids floating on the surface of a molten glass bath. In the fining zone, glass is homogenized and defects, such as bubbles or “seeds” are driven out. It should be noted that some fining takes place in the melting zone, and there is no definitive line of demarcation between the fining zone and the melting zone. However, one of ordinary skill in the art will readily understand what is meant by these terms. Glass is continuously withdrawn from the fining zone. The melting zone and the fining zone of a glass tank may be present in a single chamber or the glass tank may consist of two or more connected and distinct chambers.

The glass-making materials are melted in the melting zone by a series of burners 40, which, as described further below, can be air-fuel burners or oxygen-fuel burners. In some embodiments, the furnace 10 is of the side-port regenerative heating type. In such embodiments, the furnace has regenerators on either side to pre-heat combustion air for the air-fuel burners. In some embodiments, a series of burners are provided in each side of the furnace to melt and fine the glass making materials. These burners are generally longitudinally spaced from each other, such that upstream burners are in the melting zone and downstream burners are in the fining zone. As shown in the Figures, these burners 40 can be referred to in numerical order starting with the number 1 burner nearest the charging end 20. In some embodiments, the furnace includes between 4 and 16 (e.g., 6) burners on each side. The air-fuel burners on each side typically alternate, such that the burners from a first side simultaneously fire while the burners on the other side do not fire. After a predetermined period of time the system reverses such that the previously firing air-fuel burners do not fire and the previously unfired air-fuel burners simultaneously fire, and this sequence is repeated. In general, in some embodiments, the provided oxygen-fuel burners fire continuously, while the air-fuel burners fire alternately by side as previously described. In some embodiments, the burners are positioned to direct flames directly across the glass making materials and molten glass. Exhaust gas from the flames can be removed through heat recovery devices to improve the overall furnace efficiency, thereby reducing fuel consumption.

In certain embodiments, burners combusting natural gas and air are used to at least partially melt and/or fine the glass making materials. Because the fuel is combusted with air, large amounts of nitrogen and other generally noncombusting gasses are introduced into the furnace. Air-fuel combustion is defined as combustion where the oxidant stream is between about 21% and 40% oxygen. The air and fuel (e.g., natural gas) are delivered to the air-fuel burners via respective air and fuel storage and delivery systems for mixing and combustion to produce a flame generally directed at the glass-making ingredients. It will be understood that phrasing use herein such as “melting” or “fining” with an air-fuel burner refers to such actions with a flame from such a burner.

Embodiments of the invention also include the use of oxygen-fuel burners, which combust fuel with a gas having a substantially greater percentage of oxygen than air. Oxygen-fuel burners create hotter flames than conventional burners fired with air. For the purposes of this disclosure, oxygen-fuel combustion is defined as combustion where the oxidant stream is between 90 and 100% oxygen, and preferably greater than 95% oxygen (e.g., over 98% oxygen). The oxygen-fuel burners may be of any type useful for directing flames onto or near glass-making materials or molten glass. Any premixing burner will work. The oxygen and fuel are delivered to the oxygen-fuel burners via respective oxygen and fuel storage and delivery systems for mixing and combustion to produce a flame generally directed at the glass-making ingredients. It will be understood that phrasing use herein such as “melting” or “fining” with an oxygen-fuel burner refers to such actions with a flame from such a burner.

Controllers are provided to control the gas flow from the oxygen supply and the fuel supply so as to achieve a desired ratio of oxygen to fuel. In some embodiments, the stoichiometric ratio of oxygen to fuel (e.g., natural gas) is greater than about 1.7 (e.g., greater than about 2). In other embodiments, the ratio of oxygen to fuel (e.g., natural gas) is greater than about 2.3 (e.g., about 2.5). Accordingly, in some embodiments of the invention, the burner is ran “oxygen rich,” or supplied with a greater amount of oxygen that is stoichiometrically required to combust the fuel. It should be noted that every oxygen-fuel burner does not have to be operated at the same oxygen to fuel ratio. In general, it will be desirable to run the more downstream burners at a higher oxygen to fuel ratio than any upstream burners to provide a more oxidative environment downstream. Applicants have discovered the surprising result that the transmittance value of the finished glass product can be significantly increased by the use of oxygen-fuel burners, particularly in downstream locations.

Embodiments of the invention include a method of increasing transmittance in glass using the oxygen-fuel burners described above. In some embodiments, the method includes the step of introducing glass forming ingredients into the melting zone M of the furnace 10 and melting the glass-forming ingredients in the melting zone with air-fuel burners and/or oxygen-fuel burners. In some embodiments, the molten glass is fined in the fining zone F with air-fuel and/or oxygen-fuel burners directed toward the molten glass. However, at least one of the burners 40 in the fining zone is an oxygen-fuel burner. The use of oxygen burners in accordance with embodiments of the invention provides an oxygen rich environment in the furnace, which in turn further oxidizes some glass forming ingredients, such as iron, without the use of oxidizers, such as cerium. Such a method increases the transmittance of the finished glass product, rendering the glass product particularly useful for glass-based solar cell applications.

The oxygen-fuel burners and the air-fuel burners can be located in a variety of positions to achieve this result. In certain embodiments, each burner in the melting zone includes an air-fuel burner and each burner in the fining zone includes an air-fuel burner except the last (in reference to the direction of glass making material travel, shown as “D” in FIG. 1) burner includes an oxygen-fuel burner. In other embodiments, the first burner (i.e., the number 1 burner nearest the charging end) on each side in the melting zone includes an oxygen-fuel burner and the remaining burners in the melting zone include air-fuel burners and each burner in the fining zone includes an air-fuel burner except the last (in reference to the direction of glass making material travel) burner includes an oxygen-fuel burner. Other embodiments include either of the embodiments discussed above, except that the last several (e.g. two) burners in the fining zone are oxygen-fuel burners. In yet other embodiments, the first burner includes an air-fuel burner and the last burner includes an oxygen-fuel burner, and each burner between the first and last burners include either air-fuel burners or oxygen-fuel burners. In other embodiments, the first burner includes an air-fuel burner and the last burner includes an oxygen-fuel burner, and the burners between the first and last burners all include air-fuel burners. In yet other embodiments, the first burner includes an oxygen-fuel burner and the last burner includes an oxygen-fuel burner, and the burners between the first and last burners include either air-fuel burners or oxygen-fuel burners. In some embodiments, the first burner includes an oxygen-fuel burner and the last burner includes an oxygen-fuel burner, and the burners between the first and last burners all include air-fuel burners. In yet other embodiments, each burner in the furnace includes an oxygen-fuel burner and none of the burners in the furnace include air-fuel burners. Such embodiments have been found to substantially increase the solar and transmission values of the finished glass products, which make the finished glass particularly useful in glass based solar panels.

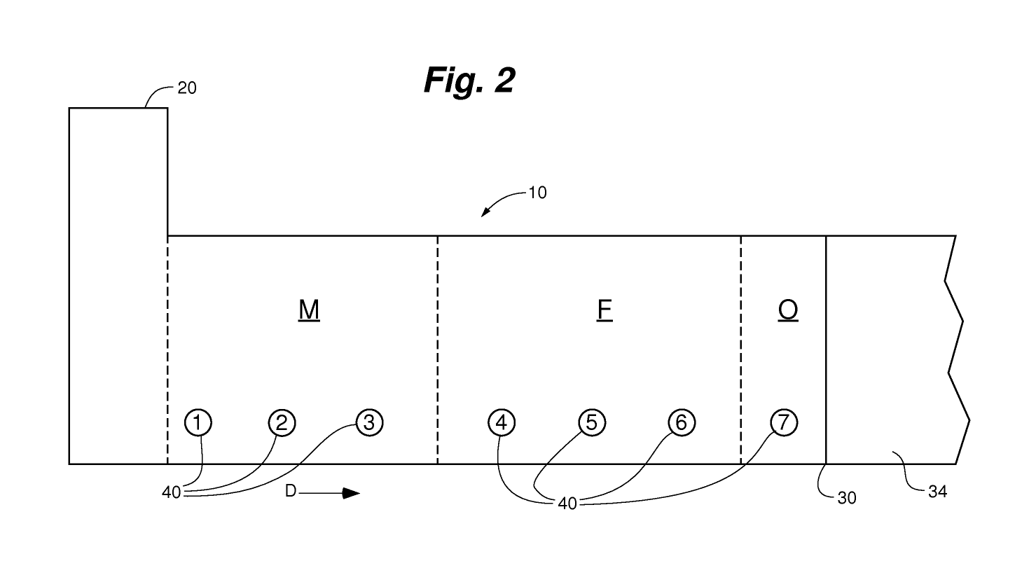

As shown in FIG. 2, some embodiments include an oxygenation zone O. In the embodiment shown in FIG. 2, the oxygenation zone is provided between the fining zone and the float bath, although additional fining may occur in the oxygenation zone. In other embodiments, the oxygenation zone overlaps partially or completely with the fining zone. In yet other embodiments, the oxygenation zone overlaps partially or completely with the fining zone and the melting zone. In all embodiments, the oxygenation zone provides an oxidative atmosphere in contact with the melted glass forming ingredients. Such a zone is useful for oxidizing ferrous iron to ferric iron to further increase transmittance of the finished glass. In embodiments having such a dedicated zone, the oxygenation zone can include, for example, between 1 and 4 oxygen-fuel burners on each side of the zone. In some embodiments, the residence time of the melted glass forming ingredients in the oxygenation zone is increased to allow more time for oxidation. For example, in some embodiments the incorporation of an oxygenation zone into the furnace creates a longer furnace than would otherwise be necessary for fining to increase. The burners in the melting and fining zones can be all air-fuel burners or any other the various configurations discussed above.

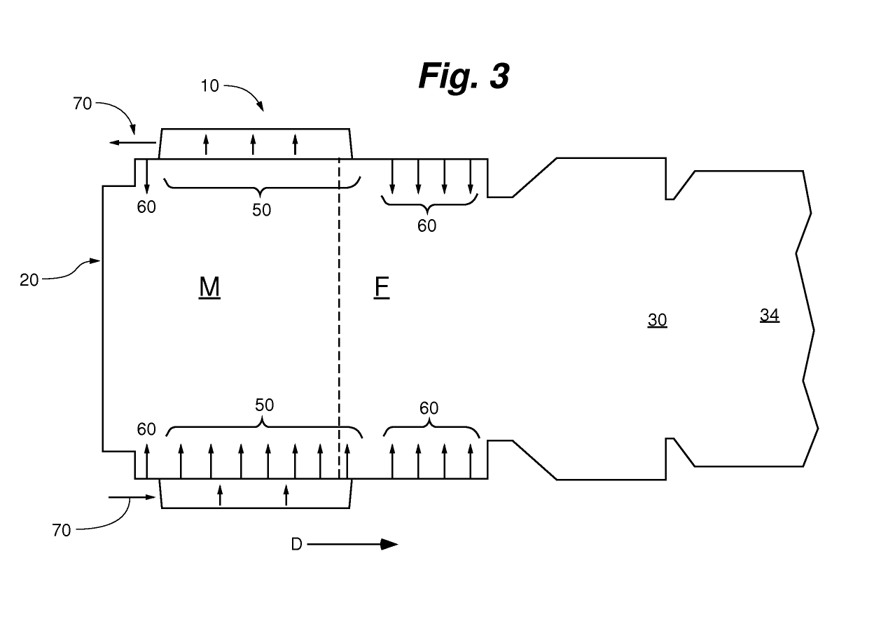

FIG. 3 provides a top schematic view of an embodiment of the invention. In FIG. 3, air-fuel burners are designated as 50 and oxygen-fuel burners are designated as 60. These burner locations are not explicitly shown. Rather, they are depicted as arrows indicating the direction of flame travel. In FIG. 3, the row of air-fuel burners 50 shown at the bottom of the figure are depicted as firing, while the row shown at the top of the figure are not firing. In the embodiment of FIG. 3, air-fuel burners 50 combusting natural gas and air 70 are used to at least partially melt and/or fine the glass making materials. Further, oxygen-fuel burners 60 are provided as shown.

In FIG. 3, the first burner downstream from the charge end 20 is an oxygen-fuel burner 60. The next several burners in the melting zone M are air-fuel burners 50. At least the first burner in the fining zone F is also an air-fuel burner 50. As shown, the next several burners in the fining zone F are oxygen-fuel burners 60. The glass proceeds past these burners to the discharge end 30, to the float section 34, and onward to cutting and packing (not shown).

Examples of glass that can be made with embodiments of the invention include silica based glass. The method is particularly useful in making a high transmittance, low-iron glass. Without intending to be bound by theory, it appears that methods in accordance with the invention are useful for converting (i.e., oxidizing) a relatively absolute amount of ferrous iron to ferric iron. Accordingly, as the amount of iron is reduced in the glass, a relatively greater percentage of the ferrous iron is converted to ferric iron, leading to the increase in transmittance described herein. Conversely, as the total amount of iron in the batch rises, a relatively smaller portion of it will be converted into ferric iron by the methods described herein, and the change in transmission is not as pronounced.

In certain example embodiments of this invention, the glass making ingredients include, by weight percent: SiO₂ 67-75%, Na₂O 10-20%, CaO 5-15%, and total iron (expressed as Fe₂O₃) 0.005% to 0.12% (e.g., 0.01 to 0.12%). In other embodiments, the total iron is about 0.02 to about 0.09%. In yet other embodiments, the total iron is about 0.03 to about 0.08%. Other embodiments include iron at about 0.04 to about 0.07%. Yet other embodiments include iron in about 0.04 to about 0.06%. Some embodiments include glass with a total iron content of less than about 0.07%. Other embodiments include glass with a total iron content of less than about 0.06%. Yet other embodiments include glass with a total iron content of less than about 0.05%.

It has surprisingly been found that using the oxygen-fuel burners in the manner described herein, when making glass of this low-iron type, have allowed resulting glasses to achieve higher visible and near infrared transmissions without resulting in significant glass defects or the disadvantages found in prior oxidation approaches.

In some embodiments, the percentage of iron in the ferrous state in the finished glass product is less than about 5%. In other embodiments, the percentage of iron in the ferrous state is less than about 3%. In yet other embodiments, the percentage of iron in the ferrous state is less than about 1% (e.g., between about 0.5% and about 0.7%).

Accordingly, glass made in accordance with embodiments of the invention includes relatively low redox ratios (which can be defined as the ratio of iron in the ferrous state to total iron in the glass) compared to traditional glass. In some embodiments, the redox ratio is less than about 0.3. In other embodiments, the redox ratio is less than about 0.2. In yet other embodiments, the redox ratio is between about 0.15 and about 0.2 (e.g., about 0.19).

The batch redox number of the glass-making materials can be greater than about +5. In some embodiments, the batch redox number is greater than about +10. In yet other embodiments, the batch redox number is greater than about +15 (e.g., about +15). In some embodiments, the batch redox number of the glass-making materials is less than about +20. In other embodiments, the batch redox number of the glass-making materials is between about +10 and about +20.

Glass made in accordance with embodiments of the invention provides excellent transmittance. Transmittance numbers provided herein are for a glass thickness of 3.2 millimeters. In some embodiments, the total solar transmittance of glass made in accordance with embodiments of the invention is more than about 87%. In other embodiments, total solar transmittance is more than about 88%. In yet other embodiments, total solar transmittance is more than about 89%. In some embodiments, total solar transmittance is between about 89% and about 90%. In yet other embodiments, total solar transmittance is between about 89% and about 91.5%. In some embodiments, these numbers are more than about 0.5% higher compared to identical glass made without the oxygen-fuel burner. In other embodiments, these numbers are more than about 1% higher compared to identical glass made without the oxygen-fuel burner. Such an effect is a dramatic increase in transmission in this high transmission range, which is useful for applications such as glass-based solar cells.

In some embodiments, the visible transmittance of glass made in accordance with embodiments of the invention is more than about 88%. In other embodiments, visible transmittance is more than about 89%. In yet other embodiments, visible transmittance is more than about 90%. In some embodiments, visible transmittance is between about 90% and about 91%. In other embodiments, visible transmittance is between about 90% and about 92.5%.

Embodiments of the invention allow the transmittance numbers above to be achieved without adding significant amounts of additional oxidizers, which can have their own disadvantages. In certain embodiments, the transmittance numbers above can be achieved with less than 0.01 wt. % of cerium or cerium oxide in the glass. Such embodiments are beneficial, because cerium can regain its color over time, thereby reducing initial transmittance values. In other embodiments, the transmittance numbers can be achieved with less than about 0.01 wt. % of antimony or antimony containing compounds or oxides. Such embodiments are useful because antimony is generally considered incompatible with a tin float bath. In yet other embodiments, the transmittance numbers can be achieved with less than 0.01 wt. % of cerium or cerium oxide and less than about 0.01 wt. % of antimony or antimony containing compounds or oxides.

The high transmittance values of the glass described above allows it to be particularly useful for glass-based solar cell applications and for use as the top layer of silicon cells (e.g., poly and monocrystalline cells). An example of a glass-based solar cell is described in Applicant's US Patent Pub. No. 2009/0320921, titled Photovoltaic Glazing Assembly and Method, and published Dec. 31, 2009, the contents of which are hereby incorporated by reference. Photovoltaic devices are used to convert solar radiation into electrical energy. Accordingly, glass produced by embodiments of the invention is useful for inclusion in a glass-based solar cell, such as a photovoltaic glazing assembly. In some embodiments, the photovoltaic glazing assembly includes a first substrate formed of glass produced in accordance with the present invention and a second substrate which may also be produced in accordance with the present invention. The first and second substrates are generally planar and each have first and second major surfaces. Each second surface has a central region and a periphery, and the second surfaces face each other. In some embodiments, the two substrates are generally parallel to each other and separated by a gap. Generally, a photovoltaic coating is present on the inside surface of the first substrate. Accordingly, in order to increase the efficiency of the solar cell, it is desirable that the first substrate have high solar transmittance in order to maximize the amount of solar energy reaching the photovoltaic coatings.

Materials used in the photovoltaic coating may include cadmium sulfide, cadmium telluride, copper-indium selenide, copper indium/gallium diselenide, gallium arsenide, organic semiconductors (such as polymers and small-molecule compounds like polyphenylene vinylene, copper phthalocyanine, and carbon fullerenes) and thin film silicon. Suitable film thicknesses, layer arrangements, and deposition techniques are well known for such layers. The coating can include one or more of the following: a sodium ion diffusion barrier layer, a TCO layer, and a buffer layer. Suitable materials, film thicknesses, layer arrangements, and deposition techniques are well known for such layers.

### Examples

The following glass-making materials were introduced to a float-glass line with a furnace having seven burner ports on each side. The first port included an oxygen-fuel burner burning oxygen to natural gas at a ratio of about 2.0 to 1. The second through sixth burners were air- fuel burners. The seventh burner was located downstream of the regenerators and was an oxygen-fuel burner burning oxygen to natural gas at a ratio of about 2.2 to 1.

TABLE 1
Examples of Glass Making Ingredients

| | Example 1 | | Example 2 | | Example 3 | | Example 4 | |
|---|---|---|---|---|---|---|---|---|
| Sample | Raw | Norm. | Raw | Norm. | Raw | Norm. | Raw | Norm. |
| SiO2 | 72.46 | 72.5 | 72.39 | 72.5 | 72.45 | 72.54 | 72.42 | 72.55 |
| Al2O3 | 0.56 | 0.56 | 0.57 | 0.57 | 0.56 | 0.56 | 0.57 | 0.57 |
| Fe2O3 | 0.052 | 0.052 | 0.053 | 0.053 | 0.045 | 0.045 | 0.042 | 0.042 |
| CaO | 8.74 | 8.74 | 8.74 | 8.76 | 8.75 | 8.76 | 8.74 | 8.76 |
| MgO | 3.77 | 3.77 | 3.77 | 3.78 | 3.78 | 3.78 | 3.78 | 3.79 |
| Na2O | 13.91 | 13.92 | 13.87 | 13.89 | 13.84 | 13.86 | 13.81 | 13.83 |
| K2O | 0.16 | 0.16 | 0.16 | 0.16 | 0.16 | 0.16 | 0.16 | 0.16 |
| SO3 | 0.27 | 0.27 | 0.26 | 0.26 | 0.19 | 0.29 | 0.3 | 0.3 |
| TiO2 | 0.01 | 0.01 | 0.01 | 0.01 | 0.01 | 0.01 | 0.01 | 0.01 |
| SrO | <0.01 | <0.01 | <0.01 | <0.01 | <0.01 | <0.01 | <0.01 | <0.01 |
| ZrO2 | <0.03 | <0.03 | <0.03 | <0.03 | <0.03 | <0.03 | <0.03 | <0.03 |
| BaO | 0.01 | 0.01 | 0.01 | 0.01 | <0.01 | <0.01 | <0.01 | <0.01 |
| MnO | <0.007 | <0.007 | <0.007 | <0.007 | <0.007 | <0.007 | <0.007 | <0.007 |
| Cr2O3 | <0.001 | <0.001 | <0.001 | <0.001 | <0.001 | <0.001 | <0.001 | <0.001 |
| CeO2 | <0.01 | <0.01 | 0.01 | 0.01 | <0.01 | <0.01 | <0.01 | <0.01 |
| Total | 99.94 | 100 | 99.85 | 100 | 99.87 | 100 | 99.83 | 100 |

These examples produced glass having an average total solar transmittance of 89.3%, average visible transmittance of 90.74%, and average UV transmittance of 87.84%.

The average percentage of iron in the ferrous state in these examples was 0.6%. The average redox ratio was about 0.19, and the average batch redox number was +15.4.

Note that although the following materials were not deliberately added to the batch they may be present at very small amounts because they are in other raw material feeds: cobalt, erbium, zinc, antimony, titanium, cerium, and boron.

While some preferred embodiments of the invention have been described, it should be understood that various changes, adaptations and modifications may be made therein without departing from the spirit of the invention.

What is claimed is:

1. A method of increasing transmittance in glass, comprising the steps of:
introducing glass forming ingredients including silica and iron into a furnace having a melting zone and a fining zone downstream of the melting zone, at least some of the iron being in the ferrous form;
melting the glass forming ingredients into molten glass in the melting zone with at least one burner directed toward the glass forming ingredients;
fining the molten glass in the fining zone with at least one burner directed toward the molten glass, at least one of the burners in the fining zone being an oxygen-fuel burner; and
increasing the transmittance of the glass by oxidizing at least some of the ferrous iron to a ferric form with oxygen from the oxygen-fuel burner.

2. The method of claim 1, wherein each burner in the melting zone is an air-fuel burner and each burner in the fining zone is an air-fuel burner except a last burner, which is an oxygen-fuel burner.

3. The method of claim 1, wherein a first burner on each side in the melting zone is an oxygen-fuel burner and the remaining burners in the melting zone are air-fuel burners, and each burner in the fining zone is an air-fuel burner except a last burner, which is an oxygen-fuel burner.

4. The method of claim 1, wherein the fining zone has at least two burners, and further wherein at least the last two burners in the fining zone are oxygen-fuel burners.

5. The method of claim 1, wherein a first burner is an air-fuel burner and a last burner is an oxygen-fuel burner, and each burner between the first and last burners is either an air-fuel burner or an oxygen-fuel burner.

6. The method of claim 1, wherein a first burner is an air-fuel burner and a last burner is an oxygen-fuel burner, and the burners between the first and last burners are air-fuel burners.

7. The method of claim 1, wherein a first burner is an oxygen-fuel burner and a last burner is an oxygen-fuel burner, and the burners between the first and last burners are either air-fuel burners or oxygen-fuel burners.

8. The method of claim 1, wherein a first burner is an oxygen-fuel burner and a last burner is an oxygen-fuel burner, and the burners between the first and last burners are all air-fuel burners.

9. The method of claim 1, wherein the burners are disposed along both sides of the furnace, the oxygen-fuel burner being disposed in a most downstream burner location.

10. The method of claim 1, wherein the burners are disposed along both sides of the furnace, the oxygen-fuel burner being disposed in a burner location immediately preceding a float bath.

11. The method of claim 1, wherein the glass making materials include a total iron content of about 0.005 to about 0.12%.

12. The method of claim 1, wherein the oxygen-fuel burners are fired with a stoichiometric ratio of oxygen to fuel greater than 2.

13. The method of claim 1, wherein the burners are directed generally transverse to the path of travel of the molten glass in a side fired furnace.

14. The method of claim 1, further including an oxygenation zone disposed between the fining zone and a float bath, the oxygenation zone having at least one oxygen-fuel burner.

15. The method of claim 1, wherein the method increases the transmission of the glass total at least about 0.5% compared to an identical process substituting no burners or air-fuel burners for the oxygen-fuel burners.

16. The method of claim 1, wherein the glass making ingredients include, by weight percent:
SiO₂ 67-75%, Na₂O 10-20%, CaO 5-15%, and total iron (expressed as Fe₂O₃) 0.01 to 0.12%.

17. A method of increasing total solar transmittance in glass, comprising the steps of:
introducing glass forming ingredients including silica and iron into a furnace having a melting zone and a fining zone downstream of the melting zone, the glass making materials including a total iron content of less than about 0.12%, and at least some of the iron being in the ferrous form;
melting the glass forming ingredients into molten glass in the melting zone with at least one burner directed toward the glass forming ingredients;
fining the molten glass in the fining zone with at least one burner directed toward the molten glass, at least one of the burners in the fining zone being an oxygen-fuel burner fired with a stoichiometric ratio of oxygen to fuel greater than 2; and
increasing the total solar transmittance of the finished glass by oxidizing at least some of the ferrous iron to a ferric form with oxygen from the oxygen-fuel burner, the total solar transmittance of the finished glass being more than about 88%.

18. The method of claim 17, wherein each burner in the melting zone is an air-fuel burner and each burner in the fining zone is an air-fuel burner except a last burner, which is an oxygen-fuel burner.

19. The method of claim 17, wherein a first burner on each side in the melting zone is an oxygen-fuel burner and the remaining burners in the melting zone are air-fuel burners, and each burner in the fining zone is an air-fuel burner except a last burner, which is an oxygen-fuel burner.

20. The method of claim 17, wherein the fining zone has at least two burners, and further wherein at least the last two burners in the fining zone are oxygen-fuel burners.

21. The method of claim 17, wherein a first burner is an air-fuel burner and a last burner is an oxygen-fuel burner, and each burner between the first and last burners is either an air-fuel burner or an oxygen-fuel burner.

22. The method of claim 17, wherein the burners are disposed along both sides of the furnace, the oxygen-fuel burner being disposed in a most downstream burner location.

23. The method of claim 17, wherein the burners are disposed along both sides of the furnace, the oxygen-fuel burner being disposed in a burner location immediately preceding a float bath.

24. The method of claim 17, wherein the method increases the transmission of the glass total at least about 0.5% compared to an identical process substituting no burners or air-fuel burners for the oxygen-fuel burners.

25. The method of claim 17, wherein the glass making ingredients include, by weight percent:
SiO₂ 67-75%, Na₂O 10-20%, and CaO 5-15%.

26. A method of increasing total solar transmittance in glass, comprising the steps of:
introducing glass forming ingredients including silica and iron into a furnace having a melting zone and a fining zone downstream of the melting zone, the glass making materials including a total iron content of less than about 0.12%, and at least some of the iron being in the ferrous form, the glass forming ingredients including less than about 0.01% cerium;
melting the glass forming ingredients into molten glass in the melting zone with at least one burner directed toward the glass forming ingredients;
fining the molten glass in the fining zone with at least one burner directed toward the molten glass, at least one of the burners in the fining zone being an oxygen-fuel burner fired with a stoichiometric ratio of oxygen to fuel greater than 2; and
increasing the total solar transmittance of the finished glass by oxidizing at least some of the ferrous iron to a ferric form with oxygen from the oxygen-fuel burner, the total solar transmittance of the finished glass being more than about 88%.

27. The method of claim 26, wherein each burner in the melting zone is an air-fuel burner and each burner in the fining zone is an air-fuel burner except a last burner, which is an oxygen-fuel burner.

28. The method of claim 26, wherein a first burner on each side in the melting zone is an oxygen-fuel burner and the remaining burners in the melting zone are air-fuel burners, and each burner in the fining zone is an air-fuel burner except a last burner, which is an oxygen-fuel burner.

29. The method of claim 26, wherein the fining zone has at least two burners, and further wherein at least the last two burners in the fining zone are oxygen-fuel burners.

30. The method of claim 26, wherein a first burner is an air-fuel burner and a last burner is an oxygen-fuel burner, and each burner between the first and last burners is either an air-fuel burner or an oxygen-fuel burner.

31. The method of claim 26, wherein the burners are disposed along both sides of the furnace, the oxygen-fuel burner being disposed in a most downstream burner location.

32. The method of claim 26, wherein the burners are disposed along both sides of the furnace, the oxygen-fuel burner being disposed in a burner location immediately preceding a float bath.

33. The method of claim 26, wherein the method increases the transmission of the glass total at least about 0.5% compared to an identical process substituting no burners or air-fuel burners for the oxygen-fuel burners.

34. The method of claim 26, wherein the glass making ingredients include, by weight percent:
SiO₂ 67-75%, Na₂O 10-20%, and CaO 5-15%.

35. A method of increasing total solar transmittance in glass, comprising the steps of:
introducing glass forming ingredients including silica and iron into a furnace having a melting zone and an oxygenation zone downstream of the melting zone, the glass making materials including a total iron content of less than about 0.12%, and at least some of the iron being in the ferrous form, wherein the glass forming ingredients include less than about 0.01% cerium;
melting the glass forming ingredients into molten glass in the melting zone with at least one burner directed toward the glass forming ingredients; and
oxidizing the glass forming ingredients in the oxygenation zone with at least one oxygen-fuel burner fired with a stoichiometric ratio of oxygen to fuel greater than 2 directed toward the molten glass to increase the total solar transmittance of the finished glass by oxidizing at least some of the ferrous iron to a ferric form with oxygen from the oxygen-fuel burner.

36. The method of claim 35, wherein the glass making ingredients include, by weight percent:
SiO₂ 67-75%, Na₂O 10-20%, and CaO 5-15%.

37. The method of claim 35, wherein each burner in the melting zone is an air-fuel burner and each burner in the fining zone is an air-fuel burner except a last burner, which includes an oxygen-fuel burner.

38. The method of claim 35, wherein a first burner on each side in the melting zone is an oxygen-fuel burner and the remaining burners in the melting zone are air-fuel burners, and each burner in the fining zone is an air-fuel burner except a last burner, which is an oxygen-fuel burner.

39. The method of claim 35, wherein the fining zone has at least two burners, and further wherein at least the last two burners in the fining zone are oxygen-fuel burners.

40. The method of claim 35, wherein a first burner is an air-fuel burner and a last burner is an oxygen-fuel burner, and each burner between the first and last burners is either an air-fuel burner or an oxygen-fuel burner.
